(19) United States
(12) Patent Application Publication
(10) Pub. No.: US 2025/0136047 A1
(43) Pub. Date: May 1, 2025

(54) SYSTEMS AND METHODS FOR KEYLESS OPERATION

(71) Applicant: Irdeto B.V., Hoofddorp (NL)

(72) Inventor: Yansong GAO, Beijing (CN)

(21) Appl. No.: 18/833,349

(22) PCT Filed: Jan. 27, 2022
(86) PCT No.: PCT/CN2022/074276

§ 371 Date: Jul. 25, 2024

(51) Int. Cl. B60R 25/24; G07C 9/00; H04W 12/50

(52) U.S. Cl. CPC B60R 25/24; G07C 9/00309; G07C 9/00658; H04W 12/50; B60R 2325/101; B60R 2325/108

(57) ABSTRACT

There is provided systems and methods for operating a keyless vehicle system of a vehicle. One such method comprises, receiving, at a Bluetooth module of the keyless vehicle system a connection request from a mobile device, wherein the Bluetooth module of the keyless vehicle system is bonded as a human interface device (HID) to the mobile device. In response to the mobile device being verified by the Bluetooth module, a Bluetooth connection between the mobile device and the Bluetooth module is established. In response to the vehicle detecting physical interaction, the presence of the mobile device determined. Operation of the keyless vehicle system is allowed based on the presence of the mobile device.

### FIELD OF THE INVENTION

The present invention relates to remote keyless systems. In particular, operation of remote keyless systems with mobile devices.

### BACKGROUND OF THE INVENTION

Keyless entry and ignition systems (also known as remote keyless systems or keyless vehicle systems) have been widely adopted in the automotive field for both consumer and commercial vehicles. Such keyless systems replace the need for a physical key to unlock a physical lock, with a keyless remote (or fob) which authorizes the unlocking (or starting of the ignition) of a vehicle based on the keyless remote's proximity to (or presence within) the vehicle itself. Such keyless remotes typically communicate with the vehicle via a short range radio transmissions, with the keyless remote acting as a transponder.

Such systems provide improved convenience for user's who are able to enter and often start a vehicle without having to interact with the keyless remote, which merely needs to be present with the user. They also provide reliability improvements over physical lock and key systems where weather conditions (such as low temperatures) can cause physical locks to become inoperable, for example due to icing of the keyhole.

A disadvantage of remote keyless systems is that traditionally they have required dedicated hardware, in the form of the keyless remote for each particular vehicle. Furthermore the initial secure pairing of the keyless remote and the vehicle is typically carried out by the original equipment manufacturer (OEM) in order to maintain security of the system. This makes replacement or repair of keyless remotes difficult and costly.

Recent developments of remote keyless systems have enabled generic mobile devices (such as smartphones) to take the role of the keyless remote, often using built in communication systems or protocols such as NFC, or Bluetooth. However, such systems typically rely on a third party application running on the mobile device. Not only that but such systems usually require the user to actually interact with the mobile device itself in order to operate the vehicle (such as open a door, start the engine etc.) This can be seen as providing a retrograde step compared to dedicate hardware keyless remotes which commonly can simply be present on the user's person and enable various functionality of the vehicle by proximity.

Requiring user interaction with the mobile device for keyless remote function is often inconvenient for the user, as well as providing additional security risks, such as making the mobile device far more accessible to potential attackers when the user is in the vicinity of their vehicle.

### SUMMARY OF THE INVENTION

It is an object of the present invention to allow a mobile device, such as a smartphone, to operate as a passive keyless remote, without requiring the user to interact with the mobile device in order to operate the vehicle. As such the present invention aims to overcome the shortcomings of current mobile device as keyless remote systems, whilst maintaining the advantages of using the user's own mobile device in place of bespoke hardware, vehicle specific, keyless remotes.

According to a first aspect of the invention, there is provided a method of operating a keyless vehicle system of a vehicle, the method comprising: receiving, at a keyless vehicle system a wireless connection request from a mobile device, wherein the keyless vehicle system is bonded as a human interface device (HID) to the mobile device. Establishing a wireless connection between the mobile device and the keyless vehicle system (or wireless connection module thereof) based on (or in response to or comprising the step of) the mobile device being verified by keyless vehicles system (or a wireless connection module thereof). In response to the vehicle (or keyless vehicle system) detecting physical interaction, determining the presence of the mobile device via the wireless connection; and allowing operation of the vehicle based on the presence of the mobile device. Allowing operation of the vehicle may comprise any one or more of unlocking one or more doors (or entryways) of the vehicle; disabling an immobilizer system of the vehicle; engaging the ignition system of a vehicle (such as starting an engine, or permitting operation of an electric motor); disabling an alarm system of the vehicle, and so on. In some embodiments the wireless communication system used is a Bluetooth communication system, more preferably a Bluetooth Low Energy communication system. In such embodiments the wireless connection module of the keyless vehicle system may be a Bluetooth module. The mobile device may be a smartphone or other such smart device implementing the wireless communication system. Typically the smartphone may utilize the well-known Android operating system or the well-known iOS operating system. Verifying the mobile device may be carried out as part of establishing the wireless connection. In particular the wireless connection may be terminated (or disconnected) if the verifying is unsuccessful.

In some embodiments the keyless vehicle system comprises a keyless ignition system and/or a keyless entry system. The allowed operation may be starting (or running) the vehicle and/or unlocking (or opening) one or more doors (or entryways) respectively.

In some embodiments the physical interaction comprises any of: activating a door handle of the vehicle; pressing a button of the vehicle; activating a touch sensor of the vehicle.

In some embodiments the mobile device is verified by the keyless vehicle system (or wireless connection module thereof) successfully establishing an encrypted link layer communication session with the mobile device. Establishing the encrypted link layer communication session may use a cryptographic key stored on the keyless vehicle system and the mobile device

In some embodiments verifying the mobile device comprises verifying an identifier of the mobile device. The identifier of the mobile device may be a MAC address of the mobile device and the keyless vehicle system may store a whitelist of authorized MAC addresses.

The identifier of the mobile device may be generated using an identity key stored on the keyless vehicle system and the mobile device. In some embodiments allowing operation of the vehicle based on the presence of the mobile device comprises allowing operation of an auxiliary system of the vehicle. The auxiliary system of the vehicle may comprise any one of: an in-vehicle navigation system; an in-vehicle audio system; an in-vehicle climate control system, a seat adjustment system; a locking system; a control adjustment; or a suspension adjustment system. Additionally, or alternatively, the auxiliary system of the vehicle may be or comprise vehicle mounted equipment such as any of: a tail lift; an excavator system; an aerial work platform; lifting equipment; one or more actuators; or one or more servos.

In some embodiments determining the presence of the mobile device comprises verifying (or confirming or otherwise authenticating) the mobile device (or identity of the mobile device) and/or determining the proximity of the mobile device. For example confirming the identity of the mobile device may be carried out by the keyless vehicle system (or wireless connection module thereof): sending a key press report to the mobile device; and verifying, a response, received from the mobile device, to the key press report. Verifying the response may use a cryptographic key stored on the keyless vehicle system and the mobile device (such as a Bluetooth Long Term Key). Additionally, or alternatively confirming the identity of the mobile device may comprise the keyless vehicle system (or wireless connection module thereof) successfully re-establishing an encrypted link layer communication session with the mobile device.

In some embodiments the method further comprises discovering, by the mobile device, the Bluetooth module and initiating a connection to the Bluetooth module.

According to a second aspect of the invention there is provided a method of associating a mobile device with a keyless vehicle system of a vehicle, the method comprising: in response to the keyless vehicle system authenticating a user, enabling a paring mode of the keyless vehicle system (or wireless connection module thereof); initiating, at the mobile device, paring of the keyless vehicle system (or wireless connection module thereof) with the mobile device, to bond the keyless vehicle system (or wireless connection module thereof) as a human interface device of the mobile device, such that the mobile device is paired to the keyless vehicle system and thereby authorized to operate the keyless vehicle system. In some embodiments the wireless communication system used is a Bluetooth communication system, more preferably a Bluetooth Low Energy communication system. In such embodiments the wireless connection module of the keyless vehicle system may be a Bluetooth module. The mobile device may be a smartphone or other such smart device implementing the wireless communication system. Typically the smartphone may utilize the well-known Android operating system or the well-known iOS operating system.

In some embodiments said paring comprises storing an identifier of the mobile device at the keyless vehicle system.

In some embodiments paring comprises a cryptographic key (such as a Bluetooth Long Term Key) being exchanged between the keyless vehicle system (or wireless connection module thereof) and the mobile device.

In some embodiments authenticating a user comprises detecting a physical key corresponding to the vehicle is present in the vehicle.

In some embodiments of either the first or second aspects above the Bluetooth module is bonded with the mobile device using a HID-over-GATT profile of the Bluetooth module.

According to a third aspect of the invention there is provided apparatus arranged to carry out any of the methods of the first and second aspects (or any embodiment thereof) discussed above.

In particular there is provided a keyless vehicle system for operating a vehicle. The keyless vehicle system comprising one or more processors configured to: receive, at the keyless vehicle system a wireless connection request from a mobile device, wherein the keyless vehicle system is bonded as a human interface device (HID) to the mobile device, in response to the mobile device being verified by keyless vehicles system (or a wireless connection module thereof), establish a wireless connection between the mobile device and the keyless vehicle system (or wireless connection module thereof), in response to the vehicle (or keyless vehicle system) detecting physical interaction, determining the presence of the mobile device via the wireless connection; and allow operation of the vehicle based on the presence of the mobile device.

There is also provided a system for associating a mobile device with a keyless vehicle system of a vehicle, the system configured to: in response to the keyless vehicle system authenticating a user, enabling a paring mode of the keyless vehicle system (or wireless connection module thereof); initiating, at the mobile device, paring of the keyless vehicle system (or wireless connection module thereof) with the mobile device, to bond the keyless vehicle system (or wireless connection module thereof) as a human interface device of the mobile device, such that the mobile device is paired to the keyless vehicle system and thereby authorized to operate the keyless vehicle system.

According to a fourth aspect there is provided a method of operating a keyless ignition (or operation) system of portable construction equipment (or plant machinery or equipment), the method comprising: receiving, at a keyless ignition (or operation) system a wireless connection request from a mobile device, wherein the keyless ignition system is bonded as a human interface device (HID) to the mobile device. Establishing a wireless connection between the mobile device and the keyless ignition system (or wireless connection module thereof) based on (or in response to or comprising the step of) the mobile device being verified by keyless ignition system (or a wireless connection module thereof). In response to the of portable construction equipment (or keyless ignition system) detecting physical interaction, determining the presence of the mobile device via the wireless connection; and allowing operation of the portable plant machinery based on the presence of the mobile device. Allowing operation of the of portable construction equipment may comprise any one or more of disabling an immobilizer system of the portable construction equipment; engaging the ignition of the of portable construction equipment (such as starting an engine, or permitting operation of an electric motor); and so on.

Portable construction equipment may include (or comprise or be) non-rideable powered equipment such as any one of: electrical generators, hydraulic or pneumatic compressors. Typically such equipment will be powered by a combustion engine or motor requiring an ignition system.

In some embodiments the wireless communication system used is a Bluetooth communication system, more preferably a Bluetooth Low Energy communication system. In such embodiments the wireless connection module of the keyless vehicle system may be a Bluetooth module. The mobile device may be a smartphone or other such smart device implementing the wireless communication system. Typically the smartphone may utilize the well-known Android operating system or the well-known iOS operating system. Verifying the mobile device may be carried out as part of establishing the wireless connection. In particular the wireless connection may be terminated (or disconnected) if the verifying is unsuccessful.

In some embodiments the mobile device is verified by the keyless ignition system (or wireless connection module thereof) successfully establishing an encrypted link layer communication session with the mobile device. Establishing the encrypted link layer communication session may use a cryptographic key stored on the keyless ignition system and the mobile device

In some embodiments verifying the mobile device comprises verifying an identifier of the mobile device. The identifier of the mobile device may be a MAC address of the mobile device and the keyless ignition system may store a whitelist of authorized MAC addresses.

The identifier of the mobile device may be generated using an identity key stored on the keyless ignition system and the mobile device.

In some embodiments determining the presence of the mobile device comprises verifying (or confirming or otherwise authenticating) the mobile device (or identity of the mobile device) and/or determining the proximity of the mobile device. For example confirming the identity of the mobile device may be carried out by the keyless ignition system (or wireless connection module thereof): sending a key press report to the mobile device; and verifying, a response, received from the mobile device, to the key press report. Verifying the response may use a cryptographic key stored on the keyless ignition system and the mobile device (such as a Bluetooth Long Term Key). Additionally, or alternatively confirming the identity of the mobile device may comprise the keyless ignition system (or wireless connection module thereof) successfully re-establishing an encrypted link layer communication session with the mobile device.

In some embodiments the method further comprises discovering, by the mobile device, the Bluetooth module and initiating a connection to the Bluetooth module.

According to a fifth aspect of the invention there is provided a method of associating a mobile device with a keyless ignition system of a piece (or item) of portable construction equipment, the method comprising: in response to the keyless ignition system authenticating a user, enabling a paring mode of the keyless ignition system (or wireless connection module thereof); initiating, at the mobile device, paring of the keyless ignition system (or wireless connection module thereof) with the mobile device, to bond the keyless ignition system (or wireless connection module thereof) as a human interface device of the mobile device, such that the mobile device is paired to the keyless ignition system and thereby authorized to operate the keyless ignition system. In some embodiments the wireless communication system used is a Bluetooth communication system, more preferably a Bluetooth Low Energy communication system. In such embodiments the wireless connection module of the keyless ignition system may be a Bluetooth module. The mobile device may be a smartphone or other such smart device implementing the wireless communication system. Typically, the smartphone may utilize the well-known Android operating system or the well-known iOS operating system.

In some embodiments said paring comprises storing an identifier of the mobile device at the keyless ignition system.

In some embodiments paring comprises a cryptographic key (such as a Bluetooth Long Term Key) being exchanged between the keyless ignition system (or wireless connection module thereof) and the mobile device.

In some embodiments authenticating a user comprises detecting a physical key corresponding to the construction equipment is present with (or engaged in) the construction equipment.

In some embodiments of either the fourth or fifth aspects above the Bluetooth module is bonded with the mobile device using a HID-over-GATT profile of the Bluetooth module.

According to a sixth aspect of the invention there is provided apparatus arranged to carry out any of the methods of the fourth and fifth aspects (or any embodiment thereof) discussed above.

In particular there is provided a keyless ignition (or operation) system for operating a piece (or item) of portable construction equipment. The keyless ignition system comprising one or more processors configured to: receive, at the keyless ignition system a wireless connection request from a mobile device, wherein the keyless ignition system is bonded as a human interface device (HID) to the mobile device, in response to the mobile device being verified by keyless ignition system (or a wireless connection module thereof), establish a wireless connection between the mobile device and the keyless ignition system (or wireless connection module thereof), in response to the construction equipment (or keyless ignition system) detecting physical interaction, determining the presence of the mobile device via the wireless connection; and allow operation of the construction equipment based on the presence of the mobile device.

There is also provided a system for associating a mobile device with a keyless ignition (or operation) system of a piece (or item) of portable construction equipment, the system configured to: in response to the keyless ignition system authenticating a user, enabling a paring mode of the keyless ignition system (or wireless connection module thereof); initiating, at the mobile device, paring of the keyless ignition system (or wireless connection module thereof) with the mobile device, to bond the keyless ignition system (or wireless connection module thereof) as a human interface device of the mobile device, such that the mobile device is paired to the keyless ignition system and thereby authorized to operate (or engage or otherwise activate) the keyless ignition system.

According to a seventh aspect of the invention there is provided a computer program which, when executed by one or more processor, causes the one or more processors to carry out the method of the first or second or fourth or fifth aspect (or any embodiment thereof). The computer program may be stored on a computer readable medium.

### BRIEF DESCRIPTION OF THE DRAWINGS

Embodiments of the invention will now be described, by way of example only, with reference to the accompanying drawings, in which:

FIG. 1 illustrates a situation in which the user of a vehicle wishes to enter the vehicle and start the vehicle;

FIG. 2 schematically illustrates a method of pairing a mobile device to a keyless vehicle system;

FIG. 3 schematically illustrates a method of operating a keyless vehicle system using a mobile device;

FIG. 4 schematically illustrates an example implementation of the method of FIG. 3 using a Bluetooth communication system (such as the Bluetooth Low Energy communication system);

FIG. 5 schematically illustrates an example implementation of the method 200 of FIG. 2 using a Bluetooth communication system (such as the Bluetooth Low Energy communication system);

FIG. 6 schematically illustrates an example of a computer system 1000, such as may be used to implement the mobile device 150 or the keyless entry system 110.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

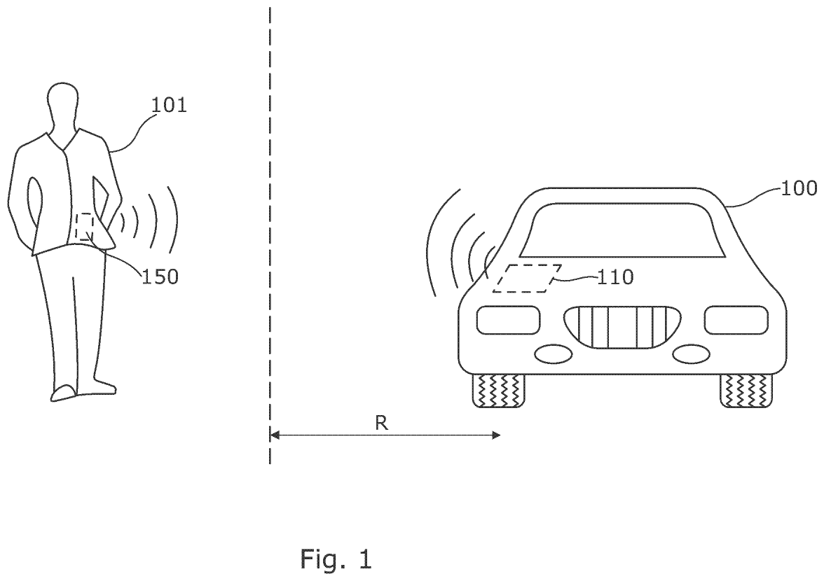

FIG. 1 illustrates a situation in which the user 101 (or operator) of a vehicle (100) wishes to enter the vehicle and start the vehicle 100. The vehicle comprises a keyless vehicle system 110 which in this example is configured to operate the door locks of the vehicle and ignition system of the vehicle.

The user 101 has a mobile device 150, typically a smartphone. As described shortly below the mobile device 150 has previously been paired (or bonded) with the keyless vehicle system 110. As the user 101 approaches the vehicle 100 with the mobile device 150, the mobile device 150 enters the range of a wireless communication system common to the mobile device 150 and the vehicle 100. In this example the common wireless communication system is a Bluetooth wireless communication system. When the mobile device 150 is in range of the vehicle 100 the mobile device detects (or discovers or otherwise identifies the presence of) the vehicle 100 via the wireless communication system. In particular, the mobile device 150 typically detects a message (or beacon) broadcast intermittently by the keyless vehicle system 110.

When the mobile device 150 and the keyless vehicle system 110 were initially paired (or bonded) the keyless vehicle system 110 was bonded as a human input device (HID) of the mobile device 150 according to the common wireless communication system. It will be understood that the keyless vehicle system 110 was in effect bonded as a peripheral (or other device) to the operating system of the mobile device 150. In the case of a Bluetooth communication system such bonding may comprise the keyless vehicle system 110 implementing an HID over GATT profile and pairing with the mobile device 150 using the HID over GATT profile. In this way the keyless vehicle system 110 has previously been identified to the mobile device 150 as an HID device (or peripheral).

Following detection of the keyless vehicle system 110 by the mobile device 150 the mobile device 150 then establishes a wireless connection with the keyless vehicle system 110 via the wireless communication system. In the present example the connection is a Bluetooth connection according to the HID over GATT profile.

The user 101 may then physically interact with the vehicle. Typically the physical interaction is an attempt to enter the vehicle 100, such as by pulling a door handle, activating a touch door handle, pressing a button on the vehicle 100 etc. In response to the vehicle 100 detecting the physical interaction the keyless vehicle system 110 detects the presence of the mobile device 150 at the vehicle 100. Typically, detecting the presence of the mobile device comprises verifying that the mobile device is within a pre-determined distance of the vehicle 100. In this way it is made more difficult for a third party to hijack the vehicle by approaching the vehicle after the user's mobile device 150 has initially detected the keyless vehicle system 110 above but prior to the user reaching the vehicle. Such verifying may be based for example on the strength of the signal received by the keyless vehicle system 110 from the mobile device 150. Additionally, or alternatively the keyless vehicle system 110 may comprise a plurality of wireless receivers and establish the distance to the mobile device based on differences of the received signal strength intensities at each receiver. It will be appreciated that in applicable wireless systems, such as Bluetooth, various known range finding techniques may be used.

In addition, the keyless vehicle system may as part of detecting the presence of the mobile device 150 validate (or re-validate) the identity of the mobile device 150 via the wireless connection. The validation of the mobile device 150 may be carried out by a challenge and response process. Typically, the validation is based on a cryptographic key (or other cryptographic entity) exchanged with the mobile device 150 during pairing. In the case of a Bluetooth connection the validation may be based on a Long Term Key (or Link Key) agreed (or shared) between the mobile device 150 and the keyless vehicle system 110 during pairing.

If the presence of the mobile device 150 is detected then the keyless vehicle system 110 allows the user access to the vehicle 100, such as by unlocking the door (or entryway). If the presence of the mobile device 150 is not detected (for example the mobile device is not within the pre-determined distance and/or the mobile device 150 fails re-validation) then the user is denied access to the vehicle.

In this way it will be understood that the user is not required to interact with the mobile device 150 in order to access the vehicle. Instead the mobile device 150 and the keyless entry system 110 automatically initiate the authentication based on the mobile device coming into range of the keyless entry system 110. This is in contrast to previous keyless entry systems operated by mobile devices where the user is required to interact with a user application (or app) on the mobile device, such as by selecting an unlock feature on the app, or ensuring the app is running at the point the user wishes to access the vehicle.

It has been discovered herein that by pairing the keyless entry system 110 with the mobile device 150 as a peripheral of the operating system, such as a human interface device, the operating system of the mobile device 150 may ensure automatic detection and establishing of a communication link with the keyless entry system 110 by the mobile device 150, without requiring that an associated application be running on the mobile device. In particular it has been discovered herein that pairing the keyless entry system 110 with the mobile device 150 enables the operating system of the mobile device 150 (such as the well-known Android and iOS operating systems) to ensure automatic detection and establishing of a communication link with the keyless entry system 110 by the mobile device 150 even if the mobile device 150 is in a sleep state, thus requiring no user interaction with the device at all to initiate the detection and establishing.

Whilst the vehicle shown in FIG. 1 is an automobile (or passenger car) it will be appreciated that the systems and methods described herein are not limited to passenger cars and can be applied to any vehicle, including Passenger vehicles (commercial or personal), Light Commercial Vehicles (such as delivery vans, work trucks, service vans, etc.), Medium or Heavy Commercial vehicles (such as transport trucks, large moving vans, heavy goods vehicles, etc.). Public Service vehicles (such as busses), trains, and so on. It will also be appreciated that the systems and methods described herein may be applied to construction vehicles including on-road construction equipment (such as dump trucks, snow plows, etc.), heavy equipment (such as back hoes, road graders, plows, cranes, excavators, etc.), light equipment (such as skid steers, material handlers including fork trucks and telehandlers, aerial access platforms etc.) It will be appreciated that the same systems may be used should the user wish to start the vehicle, with some variations. In particular, the physical interacting would typically correspond to the user pressing an ignition button (or the like) in the cabin (or cockpit) of the vehicle (though other modes of indicating a wish to start the vehicle may be envisaged). When detecting the presence of the mobile device 150 the keyless vehicle system may require that the mobile device is present within the cabin (or cockpit) of the vehicle. Such detection may be carried out in the same way as set out above, for example based on signal strength of the received communication form the mobile device. As such, if the presence of the mobile device is detected 150 following the physical interaction as set out above then the keyless vehicle system 110 may enable (or activate) the ignition system of the vehicle, or similarly enable the user to engage movement of the vehicle.

Furthermore, the same or similar systems may be used should the user wish to operate one or more auxiliary systems (or functions) of the vehicle. Such auxiliary systems may include electronic systems or functionality provided by the vehicle including: in-vehicle navigation systems; in-vehicle audio systems; in-vehicle climate control systems, seat adjustment systems; locking systems; control adjustment systems (such as steering column adjustment systems); suspension adjustment systems and so on. Additionally, or alternatively, such auxiliary systems may include vehicle mounted equipment such as: a tail lift, an excavator system (or rig), an aerial work platform, lifting equipment, one or more hydraulic (or pneumatic) actuators, one or more servos (or stepper motors), and so on. In particular, the physical interacting would typically correspond to the user interacting (or operating or otherwise using) one or more controls of the auxiliary system. When detecting the presence of the mobile device 150 the keyless vehicle system may require that the mobile device is present within the cabin (or cockpit) of the vehicle and/or within a pre-determined range or distance of the vehicle. Such detection may be carried out in the same way as set out above, for example based on signal strength of the received communication form the mobile device. As such, if the presence of the mobile device is detected 150 following the physical interaction as set out above then the keyless vehicle system 110 may enable (or permit) operation of the auxiliary system.

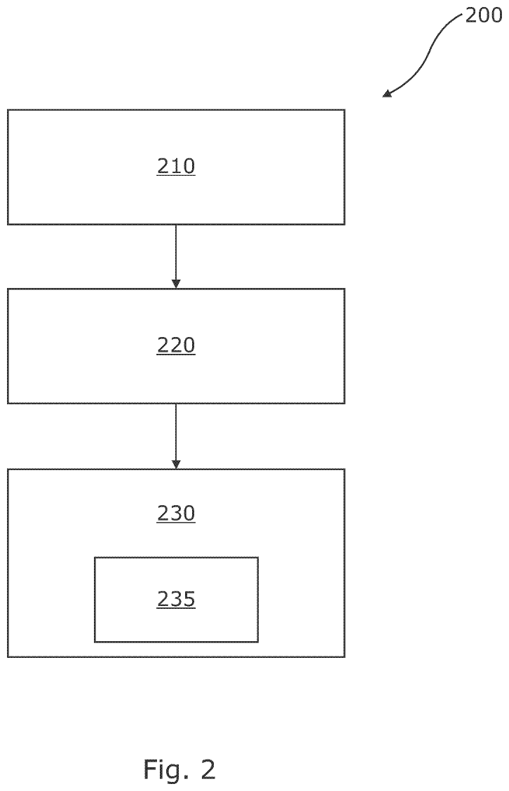

FIG. 2 schematically illustrates a method 200 of pairing (or associating) a mobile device 150 to (or authorizing a mobile device 150 in respect of) a keyless vehicle system 110.

At a step 210 the keyless vehicle system 110 authenticates a user of the mobile device 150. Typically, the step 210 comprises the keyless vehicle system 110 (or the vehicle 100) detecting the presence of an authorized physical key and/or authorized keyless remote. It will be appreciated that such detection may take the form of a traditional start-up (or ignition) of the vehicle with the key operating an ignition barrel, or the detection of the presence of a traditional keyless remote.

At a step 220 the user initiates a paring mode of the keyless vehicle system. Typically step 220 comprises the user selecting a pairing mode via an in-vehicle interface, such as an in-vehicle infotainment system or the like. The keyless vehicle system 110 may then broadcast one or more pairing (or bonding) message identifying the keyless vehicle system. Such messages are broadcast according to the wireless communication system implemented by the keyless vehicle system 110.

At a step 230 the user initiates paring mode of the mobile device 150 with the keyless vehicle system 110. The step 230 comprises bonding (or pairing) the keyless vehicle system 110 as a human interface device of the mobile device 150. Typically, the step 230 comprises the mobile device 150 detecting the keyless vehicle system 110 as a potential paring target based on a pairing message broadcast by the keyless vehicle system 110. During the paring the keyless vehicle system typically identifies to the mobile device as a human interface device. Such identification may comprise the keyless vehicle system 110 indicating (or advertising) a human interface device profile. For example, when the wireless communication system is a Bluetooth connection the keyless vehicle system may indicate (or use or advertise) the HID-over-GATT profile. It will be appreciated that Bluetooth paring is known to the skilled person, such as from the Bluetooth specification 4.2 volume 3, part H Appendix C (dated 2 Dec. 2014, available at https://www.bluetooth.com/specifications/specs/core-specification-4-2/) which is incorporated herein by reference in its entirety.

The step 230 further comprises the step 235. At the step 235 the mobile device 150 is authorized to operate the keyless vehicle system 110. Typically the step 235 is part of the paring (or bonding) sequence (or process). The step 235 may comprise one or more cryptographic keys being exchanged (or agreed) between the mobile device 150 and the keyless vehicle system 110. It will be appreciated that numerous suitable key exchange schemes would be known to the skilled person, such as Diffie-Hellman, symmetric key exchange, and so on. The step 235 may be part of the pairing process according to the wireless communication system itself. For example, where the wireless communication system is a Bluetooth system, the cryptographic key may be the Bluetooth Long Term Key exchanged as part of the Bluetooth paring process.

In a further embodiment the step 230 may comprise the keyless vehicle system 110 storing a device identifier (or public identifier) of the mobile device 150. Such an identifier may be stored as part of a whitelist (or list of permitted devices) in the keyless vehicle system, and used as discussed shortly below. An example of such a device identifier would be the well-known MAC (or media access control) address. Alternatively, where the mobile device 150 implements a private identifier (such as a private resolvable address) the keyless vehicle system 110 may store an identity key of the mobile device 150. Here the identity key may be used by the mobile device to generate private identifiers. The identity key may similarly be used by the keyless vehicle system to verify (or identify) whether a private identifier correspond to the mobile device of the identity key. An example of such a system is the Bluetooth identity resolution key system.

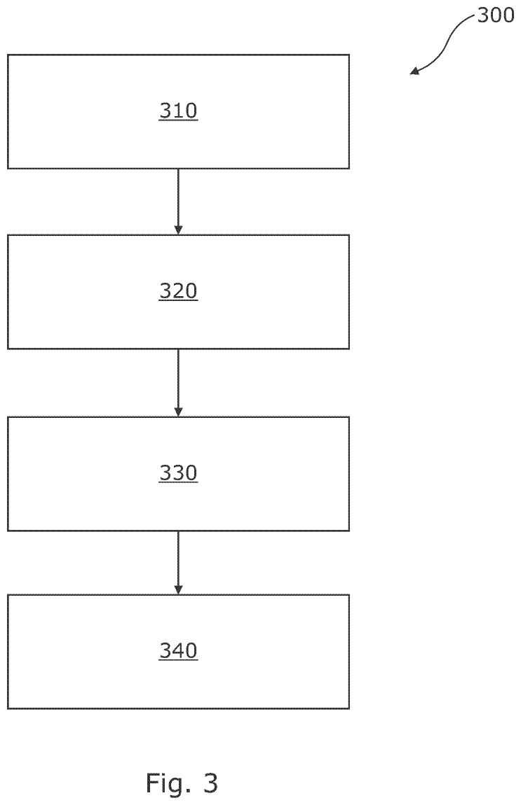

FIG. 3 schematically illustrates a method 300 of operating a keyless vehicle system 110 using the mobile device 150. In FIG. 3 the keyless vehicle system 110 has previously been bonded as a human interface device (HID) to the mobile device 150 using wireless communication system, such as by the methods discussed previously.

At a step 310 the mobile device 150 sends a connection request to the keyless vehicle system 110. Typically the connection request is sent following (or in response to) the mobile device 150 detecting the keyless vehicle system 110 based on broadcast massages sent by the keyless vehicle system.

At a step 320 the keyless vehicle system 110 verifies the mobile device 150. The step 320 may comprise verifying the mobile device 150 based on a stored cryptographic key (such as may be stored during the bonding process). In other words the step 320 may be thought of as the keyless vehicle system 110 verifying the identity (and/or authorization) of mobile device 150. The step 320 may comprise initiating or attempting to initiate a secure wireless connection between the mobile device 150 and the keyless vehicle system 110. Such a secure wireless connection (or encrypted link layer communication session) may be established using the stored cryptographic key (or keys). In this way it will be appreciated that the connection would fail to be established if the stored key at the mobile device 150 and/or the keyless vehicle system 110 is incorrect (or not according to the paring process or otherwise not as expected by either of the mobile device 150 and/or the keyless vehicle system 110). As such, the step 320 may comprise establishing a wireless connection between the mobile device 150 and the keyless vehicle system 110 in response to verifying the mobile device 150.

In an example where the wireless communication system is a Bluetooth system the steps 310 and 320 may comprise initiating link layer encryption between the mobile device 150 and the keyless vehicle system 110. This further comprises verifying the Bluetooth Long Term Key shared between the mobile device 150 and the keyless vehicle system 110 on paring. As such it will be appreciated that by attempting to initiate link layer encryption a secure Bluetooth connection will be established on the condition that the Long Term Key is verified (or present at the mobile device 150). An example of initiating of a connection is set out in the Bluetooth specification 4.2 volume 6, part D 6.6 (dated 2 Dec. 2014, available at https://www.bluetooth.com/specifications/specs/core-specification-4-2/) which is incorporated herein by reference in its entirety.

At a step 330 physical interaction with the vehicle is detected by the vehicle 100 (or keyless vehicle system 110). Such physical interaction may comprise any one or more of activating a door handle of the vehicle 100;

pressing a button of the vehicle; activating a touch sensor of the vehicle; and so on. As such it will be appreciated that the physical interaction is typically an attempt to enter (or access) the vehicle 100 and/or start the vehicle 100. The step 330 comprises, in response to detecting physical interaction with the vehicle 100, the keyless vehicle system 110 determining the presence of the mobile device 150 at the vehicle 100 via the established connection. Typically, determining the presence of the mobile device 150 comprises verifying that the mobile device is within a pre-determined distance of the vehicle 100. Such verifying may be based for example on the strength of the signal received by the keyless vehicle system 110 from the mobile device 150. Determining the presence may additionally, or alternatively comprise verifying that the mobile device 150 is inside the vehicle 100 (such as where the keyless vehicle system comprises a keyless ignition system). Such verifying may also be based on received signal strength. In either case the verifying may comprise detecting the wireless signal from the mobile device 150 using a secondary wireless receiver, where the secondary wireless receiver is tuned such as to only detect signals within the vehicle and/or of a high signal strength indicating close proximity to the vehicle (or where the secondary receiver is operable to discriminate between signals originating inside and outside of the vehicle 100).

The step 330 may also comprise validating (or re-validating) the identity of the mobile device 150 via the wireless connection. The validation of the mobile device 150 may be carried out by a challenge and response process. The validation may comprise re-running (or carrying out) the step 320. Additionally, or alternatively the validation may comprise the keyless vehicle system generating (or emulating or triggering) an input (or input event or input report) as a human interface device of the mobile device 150. The input event is sent to the mobile device 150 via the secured wireless connection. The mobile device 150 in response to receiving the input event, sends a response (or acknowledgement) to the keyless vehicle system 110 via the secured wireless connection. The keyless vehicle system 110 may then verify (or authenticate) the response (or acknowledgement) received from the mobile device 150 to thereby validate (or authenticate or establish or confirm) the identity of the mobile device 150. For example, if the response is encrypted (or secured) according to the established secure connection this may indicate that the same mobile device 150 has sent the response as has set up the secure connection, thereby validate the identity of the mobile device 150. It will be appreciated that known authenticated encryption techniques may be used for the secure connection to allow the validation of the mobile device 150 in this way. For example a CCM mode implantation of a block cipher (such as AES) may be used. Such techniques and others typically include a random value, or nonce, in the messages to resist replay attacks. The input event may comprise any one or more of: a keypress event; a click event (such as a single click, or multiples thereof); a drag event; a gesture event; and so on. It will be appreciated that the input event may be any input event defined by a human interface device.

At a step 340 operation of the vehicle is allowed (or enabled) by the keyless vehicle system based on the presence of the mobile device. The step 340 may comprise any one or more of unlocking one or more doors (or entryways) of the vehicle; disabling an immobilizer system of the vehicle; engaging the ignition system of a vehicle (such as starting an engine, or permitting operation of an electric motor); disabling an alarm system of the vehicle 100, and so on. The step 340 may comprise allowing operation one or more auxiliary systems (or functions) of the vehicle. In particular the step 340 may comprise operating (or allowing operation of) any one of: an in-vehicle navigation system; an in-vehicle audio system; an in-vehicle climate control system, a seat adjustment system; a locking system; a control adjustment system (such as steering column adjustment systems); a suspension adjustment system and so on. Additionally, or alternatively, the step 340 may comprise operating (or allowing operation of) vehicle mounted equipment such as any one of: a tail lift, an excavator system (or rig), an aerial work platform, lifting equipment, one or more hydraulic (or pneumatic) actuators, one or more servos (or stepper motors), and so on.

In a further embodiment the step 330 may also comprise the keyless vehicle system checking a device identifier of the mobile device 150 based on an expected device identifier. The expected device identifier may be a device identifier stored on the keyless vehicle system as part of the pairing process as described above in the further embodiment of FIG. 2. As such, this may be understood as the keyless vehicle system storing a whitelist of allowed (or permitted) device identifiers. If the device identifier of the mobile device 150 does not match an expected device identifier then the keyless vehicle system may refuse to establish a connection with the mobile device in step 330. An example of use of such a whitelist in establishing a wireless connection may be found in the Bluetooth specification 4.2 volume 6, part B 4.3.1 (dated 2 Dec. 2014, available at https://www.bluetooth.com/specifications/specs/core-specification-4-2/) which is incorporated herein by reference in its entirety.

Alternatively, where the mobile device 150 implements a private identifier (such as a private resolvable address) as described above in relation to FIG. 2 the keyless vehicle system 110 may check a private identifier provided by the mobile device 150 based on an identity key. For a Bluetooth wireless connection such a key is known as an Identity Resolution Key, and an example of the use of an Identity Resolution Key may be found in the Bluetooth specification 4.2 volume 6, part B 6 (dated 2 Dec. 2014, available at https://www.bluetooth.com/specifications/specs/core-specification-4-2/) which is incorporated herein by reference in its entirety.

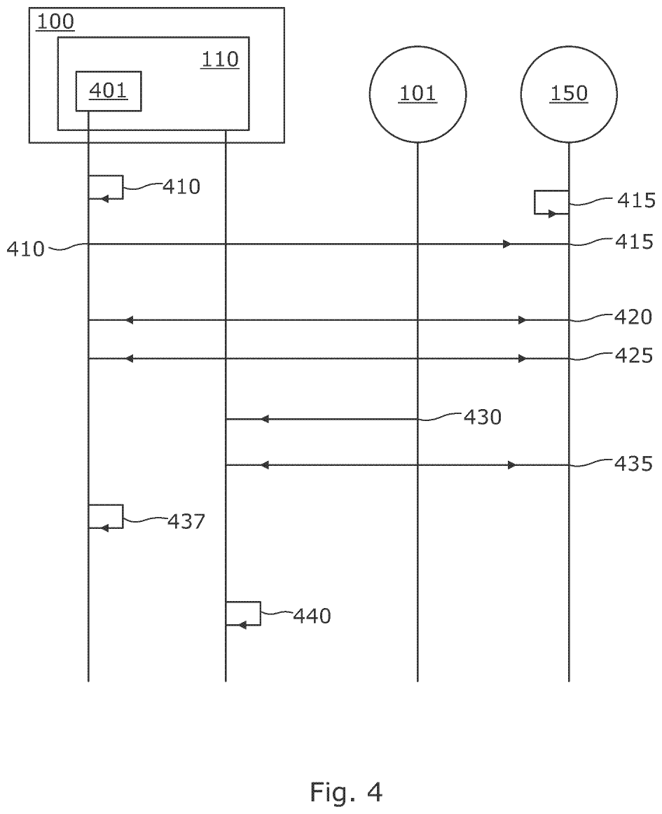

FIG. 4 schematically illustrates an example implementation of the method 300 of FIG. 3 using a Bluetooth communication system (such as the Bluetooth Low Energy communication system). In this example the keyless vehicle system 110 comprises Bluetooth module 401.

At a step 410 the Bluetooth module broadcasts availability messages indicating the presence (or availability) of the Bluetooth module 401. In this example the broadcast messages comprise Bluetooth Low Energy advertisement packets. Typically the advertising packets indicate that the Bluetooth module (and thereby the keyless vehicle system) implements (or provides) a human interface device over GATT (HID-over-GATT) profile (or service).

At a step 415 the mobile device 150 scans for bonded (or paired) Bluetooth Human Input Devices. In particular, the mobile device 150 attempts to receive broadcast messages such as those sent in the step 410.

When the user 101 with the mobile device 150 moves into range of the keyless vehicle system 110 the mobile device at step 415 receives a broadcast message sent by the Bluetooth module at step 410. Based on the received message the mobile device 150 identifies the keyless vehicle system 110 as a paired human interface device. In other words when the mobile device 150 is in range of the keyless vehicle system 110 the mobile device 150 discovers the keyless vehicle system 110 as a paired human interface device.

At a step 420 the mobile device 150 initiates an encrypted link layer session with the Bluetooth module based on the Long Term Key. Typically the step comprises the start encryption process set out in the Bluetooth specification 4.2 volume 6, part D 6.6 and part B 5.1.3.1 (dated 2 Dec. 2014, available at https://www.bluetooth.com/specifications/specs/core-specification-4-2/) which is incorporated herein by reference in its entirety. It will be appreciated that by successfully establishing the link layer session based on the Long Term Key the mobile device 150 is verified (or the identity of the mobile device confirmed) as set out above in relation to step 320 in FIG. 3. In the case of a Bluetooth Low Energy connection such verification may be thought to occur when the Bluetooth module 401 validates the LL_START_ENC_RSP message received from the mobile device 150 at the end of the start encryption process. In particular the LL_START_ENC_RSP message is typically encrypted by the mobile device with an authenticated encryption algorithm (such as AES-CCM). As such, the Bluetooth module 401 is able to authenticate the received LL_START_ENC_RSP message using the authentication inherent to the encryption algorithm. In the case of Bluetooth establishing the encrypted link layer typically involves the mobile device 150 and the Bluetooth module 401 exchanging their respective parts of a session key diversifier and an initialization vector for the session. The mobile device 150 and the Bluetooth module 401 may each then derive a common session key based on the session key diversifier, initialization vector, and the Long Term Key. This session key is then used by the mobile device to encrypt the LL_START_ENC_RSP message using AES-CCM authenticated encryption algorithm. As such, by verifying the authentication of the LL_START_ENC_RSP using the session key the Bluetooh module 401 establishes that the mobile device 150 that sent the message has the session key and therefore the Long Term Key.

At a step 425 the mobile device 150 connects to the HID over GATT service of the Bluetooth module 401 of the keyless vehicle system 110.

At a step 430 physical interaction with the vehicle 100 is detected by the keyless vehicle system 110, as set out above in relation to step 330 of FIG. 3.

At a step 435 the keyless vehicle system 110 validates (or confirms) the identity of the mobile device 150. In one example the step 435 comprises the Bluetooth module 401 sending an HID input report to the mobile device 150 via the HID-over-GATT service. In this way the Bluetooth module 401 of the keyless vehicle system 110 may be thought of as emulating (or triggering) an input event as described above in relation to step 330 of FIG. 3. The step 435 then comprises the mobile device 150 sending, to the Bluetooth module 401, a response to the key press report over the encrypted link layer. The Bluetooth module 401 may then verify that the response message is encrypted using the session key for the encrypted link layer session. As the session key was generated using the Long Term key the Bluetooth module 401 may upon successful verification determine that the mobile device 150 is the originally paired mobile device 150.

Additionally or alternatively, the step 435 comprises the Bluetooth module 401 reinitiating the encrypted link layer with the mobile device 150. In particular the Bluetooth module 401 sends a request to reinitiate the encrypted link layer. In the Bluetooth specification such a request may be comprise a “Slave Security Request”. Such a request is set out in the Bluetooth specification 4.2 volume 3, part H 2.4.6 (dated 2 Dec. 2014, available at https://www.bluetooth.com/specifications/specs/core-specification-4-2/). The step 430 may then comprise establishing a new encrypted link layer session between the mobile device and the Bluetooth module based on the Long Term Key, as set out above in step 420. In the same manner the Bluetooth module may verify the identity of the mobile device 150 based on the establishing of the new encrypted link layer session.

At a step 437 the Bluetooth module verifies (or determines) that the mobile device 150 is within a pre-determined distance of the vehicle 100. The step 435 comprises determining the range of the mobile device 150 form the Bluetooth module 401. In particular the Bluetooth module 401 determines the received signal strength intensity (RSSI) of a message received form the mobile device 150 and determines the range based on the intensity.

In this way it will be understood that the step 430 the step 435 and the step 437 implement the step 330 described above in relation to FIG. 3.

At a step 440 the keyless vehicle system 110 enables (or allows) operation of the vehicle 100 if the step 435 and the step 437 are successful. The operation of the vehicle is as set out above in relation to step 340 of FIG. 3.

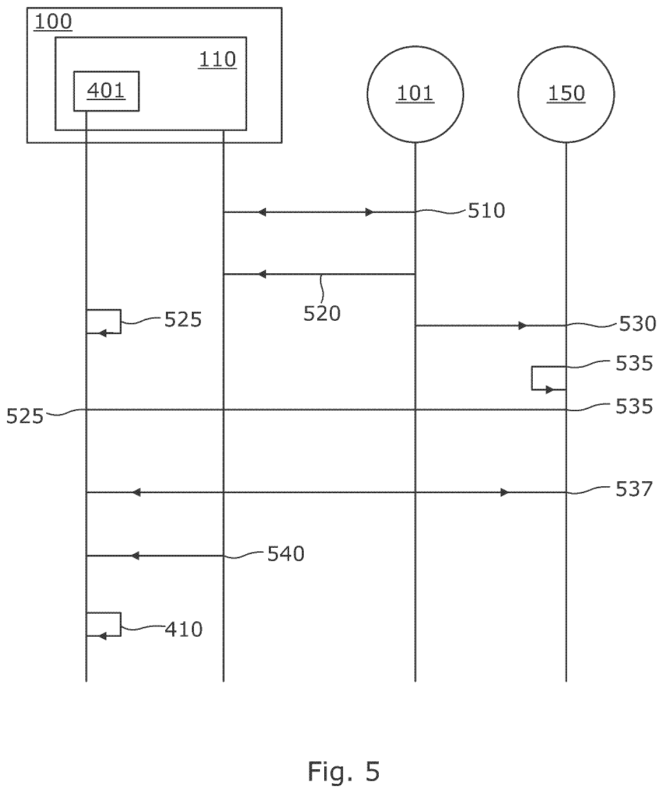

FIG. 5 schematically illustrates an example implementation of the method 200 of FIG. 2 using a Bluetooth communication system (such as the Bluetooth Low Energy communication system). In this example the keyless vehicle system 110 comprises Bluetooth module 401.

At a step 510 the keyless vehicle system 110 authenticates a user of the mobile device 150, as set out above in step 210 of FIG. 2.

At a step 520 the user initiates the Bluetooth paring mode of the keyless vehicle system, as set out above in step 220 of FIG. 2. In response to the initiation the Bluetooth module 401 begins broadcasting, at step 525, pairing messages indicating the presence (or availability) of the Bluetooth module 401 for pairing (or bonding). In this example the broadcast messages comprise Bluetooth Low Energy advertisement packets. Typically the advertising packets indicate that the Bluetooth module (and thereby the keyless vehicle system) implements (or provides) a human interface device over GATT (HID-over-GATT) profile (or service).

At a step 530 the user initiates the Bluetooth scanning mode of the mobile device 150. In response to the initiation the mobile device 150 starts, at step 535, listening for (or receiving) any pairing messages from nearby Bluetooth devices. The step 535 should include receiving a pairing message from the Bluetooth module 401. In this way the mobile device 150 discovers any nearby Bluetooth devices (including the keyless vehicle system 110) available for pairing.

At a step 535 the user selects the Bluetooth module 401 (and thereby the keyless vehicles system 110) from the list of discovered Bluetooth devices and instructs the mobile device 150 to begin pairing with the keyless vehicles system 110 as a human interface device.

At a step 537 the mobile device 150 and the Bluetooth module 401 carry out a Bluetooth pairing procedure, bonding the keyless vehicle system 110 to the mobile device 150 as a human interface device of the mobile device 150. Here the mobile device 150 is the Bluetooth master device and the keyless vehicle system 110 is the Bluetooth slave device. Such Bluetooth paring exchanges are set out, for example, in the Bluetooth specification 4.2 volume 3, part H Appendix C (dated 2 Dec. 2014, available at https://www.bluetooth.com/specifications/specs/core-specification-4-2/) which is incorporated herein by reference in its entirety. As will be understood as part of the paring process the mobile device 150 and the keyless vehicle system 110 agree (or negotiate or generate) a shared Long Term Key as discussed previously herein. Such a Long Term Key may be thought of as a shared secret between the mobile device 150 and the keyless vehicle system 110.

At a step 540 the keyless vehicle system 110 instructs the Bluetooth module to end the pairing mode. In response, the Bluetooth module 401 begins broadcasting availability messages, as per the step 410 described above in relation to FIG. 4.

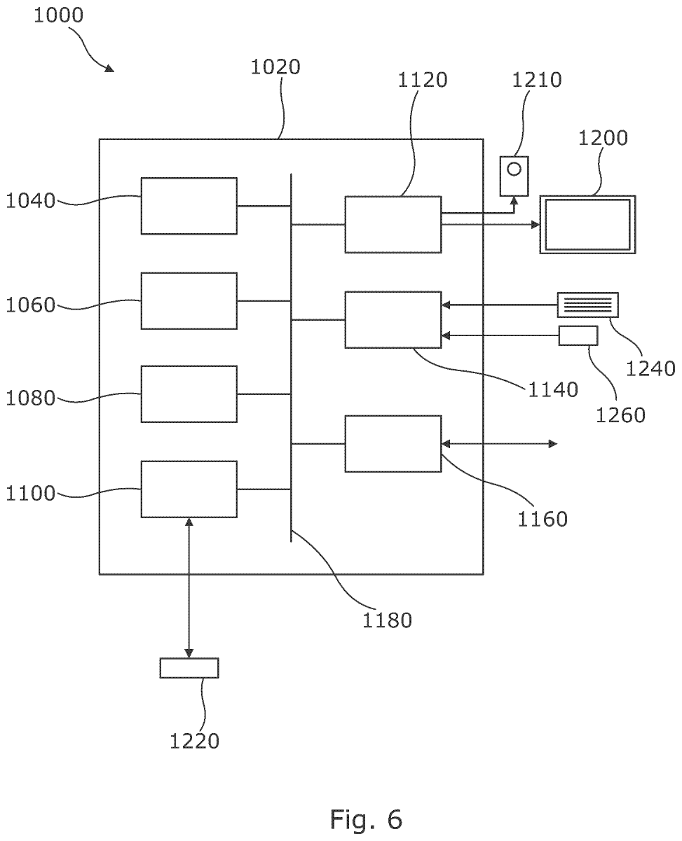

FIG. 6 schematically illustrates an example of a computer system 1000, such as may be used to implement the mobile device 150 or the keyless entry system 110. The system 1000 comprises a computer 1020. The computer 1020 comprises: a storage medium 1040, a memory 1060, a processor 1080, an interface 1100, a user output interface 1120, a user input interface 1140 and a network interface 1160, which are all linked together over one or more communication buses 1180.

The storage medium 1040 may be any form of non-volatile data storage device such as one or more of a hard disk drive, a magnetic disc, an optical disc, a ROM, etc. The storage medium 1040 may store an operating system for the processor 1080 to execute in order for the computer 1020 to function. The storage medium 1040 may also store one or more computer programs (or software or instructions or code).

The memory 1060 may be any random access memory (storage unit or volatile storage medium) suitable for storing data and/or computer programs (or software or instructions or code).

The processor 1080 may be any data processing unit suitable for executing one or more computer programs (such as those stored on the storage medium 1040 and/or in the memory 1060), some of which may be computer programs according to embodiments of the invention or computer programs that, when executed by the processor 1080, cause the processor 1080 to carry out a method according to an embodiment of the invention and configure the system 1000 to be a system according to an embodiment of the invention. The processor 1080 may comprise a single data processing unit or multiple data processing units operating in parallel or in cooperation with each other. The processor 1080, in carrying out data processing operations for embodiments of the invention, may store data to and/or read data from the storage medium 1040 and/or the memory 1060.

The interface 1100 may be any unit for providing an interface to a device 1022 external to, or removable from, the computer 1020. The device 1022 may be a data storage device, for example, one or more of an optical disc, a magnetic disc, a solid-state-storage device, etc. The device 1022 may have processing capabilities—for example, the device may be a smart card. The interface 1010 may therefore access data from, or provide data to, or interface with, the device 1022 in accordance with one or more commands that it receives from the processor 1008.

The user input interface 1140 is arranged to receive input from a user, or operator, of the system 1000. The user may provide this input via one or more input devices of the system 1000, such as a mouse (or other pointing device) 1260 and/or a keyboard 1240, that are connected to, or in communication with, the user input interface 1140. Typically these devices may be soft devices and embodied in a device such as a touchscreen operable to provide mouse 126 and keyboard 1240 input functionality. The computer 1020 may store the input received from the input devices via the user input interface 1140 in the memory 1060 for the processor 1080 to subsequently access and process, or may pass it straight to the processor 1080, so that the processor 1080 can respond to the user input accordingly.

The user output interface 1120 is arranged to provide a graphical/visual and/or audio output to a user, or operator, of the system 1000. As such, the processor 108 may be arranged to instruct the user output interface 1120 to form an image/video signal representing a desired graphical output, and to provide this signal to a monitor (or screen or display unit) 1200 of the system 1000 that is connected to the user output interface 1120. Additionally or alternatively, the processor 1080 may be arranged to instruct the user output interface 1120 to form an audio signal representing a desired audio output, and to provide this signal to one or more speakers 1210 of the system 1000 that is connected to the user output interface 1120.

Finally, the network interface 1160 provides functionality for the computer 1020 to download data from and/or upload data to one or more data communication networks. In the case of the keyless vehicle system 110 the network interface may be interfaced to a network or bus of the vehicle, such as the CAN bus of a vehicle. In this way the keyless vehicle system 110 may be enabled to operate devices on or connected to the network or bus of the vehicle. Such devices may include any one or more of: an ignition system; a (central) locking system; individual door (or entryway) locks; an immobiliser; an engine control (or management) unit of the vehicle; an electric power unit of the vehicle (such as one or more electric motors) and so on and so forth. It will also be appreciated that the vehicle itself may comprise or be controlled by a system such as the system 1000 and the keyless vehicle system 110 may be implemented as on (or as part of) such a system.

It will be appreciated that the architecture of the system 1000 illustrated in FIG. 1 and described above is merely exemplary and that other computer systems 1000 with different architectures (for example with fewer components than shown in FIG. 1 or with additional and/or alternative components than shown in FIG. 1) may be used in embodiments of the invention. As examples, the computer system 1000 could comprise one or more of: a vehicle based computing system; a mobile telephone; a tablet; a smartphone; other mobile devices or consumer electronics devices; etc.

It will be appreciated that the methods and systems described above are applicable to any vehicle, including any of: road going vehicles (such as any of cars; trucks; busses; earth moving vehicles; quarry vehicles; etc.); marine (or sea going) vehicles; aircraft; trains; etc.

Additionally, it will be understood that whilst the above methods and systems are described in relation to a vehicle they could be applied to portable plant equipment such as generators, compressors and the like or equipment comprising generators or compressors. In such cases the keyless vehicle system described above may be a keyless ignition system for the portable plant equipment. In this way the operation of the plant equipment (such as the activation of the motor or engine of the plant equipment) may be enabled or controlled by the keyless ignition system in response to determining the presence and identity of the required mobile device in the same manner as the ignition or operation of the vehicles described above are achieved.

Whilst the above description involves examples using Bluetooth and Bluetooth Low Energy connections, it will be appreciated that the above method sand systems are applicable to any wireless connection system which pairs (or bods) human interface devices at the operating system level. Whilst the above description for ease of understanding makes reference to Bluetooth 4.2 it will also be appreciated that the above methods and systems are not limited to this version of the Bluetooth system. For example, the above methods and systems are applicable using any of: Bluetooth 5.0, Bluetooth 5.1, and Bluetooth 5.2.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1-26. (canceled)

27. A method of operating a keyless vehicle system of a vehicle, the method comprising:
receiving, at a Bluetooth module of the keyless vehicle system a connection request from a mobile device, wherein the Bluetooth module of the keyless vehicle system is bonded as a human interface device (HID) to the mobile device;
in response to the mobile device being verified by the Bluetooth module, establishing a Bluetooth connection between the mobile device and the Bluetooth module;
in response to the vehicle detecting physical interaction, determining the presence of the mobile device; and
allowing operation of the vehicle based on the presence of the mobile device.

28. The method of claim 27 wherein the keyless vehicle system comprises a keyless ignition system and/or a keyless entry system.

29. The method of claim 27 wherein the physical interaction comprises any of:
activating a door handle of the vehicle;
pressing a button of the vehicle;
activating a touch sensor of the vehicle.

30. The method of claim 27 wherein the mobile device is verified by the Bluetooth module successfully establishing an encrypted link layer communication session with the mobile device.

31. The method of claim 30 wherein establishing the encrypted link layer communication session uses a cryptographic key stored on the keyless vehicle system and the mobile device, optionally wherein the cryptographic key is a Bluetooth Long Term Key.

32. The method of claim 27 wherein allowing operation of the vehicle based on the presence of the mobile device comprises allowing operation of an auxiliary system of the vehicle.

33. The method of claim 32 wherein the auxiliary system of the vehicle comprises any one of: an in-vehicle navigation system; an in-vehicle audio system; an in-vehicle climate control system, a seat adjustment system; a locking system; a control adjustment; or a suspension adjustment system.

34. The method of claim 32 wherein the auxiliary system of the vehicle comprises any one of: a tail lift; an excavator system; an aerial work platform; lifting equipment; one or more actuators; or one or more servos.

35. The method of claim 27 wherein verifying the mobile device comprises verifying an identifier of the mobile device.

36. The method of claim 35 wherein the identifier of the mobile device is:
a MAC address of the mobile device and the keyless vehicle system stores whitelist of authorized MAC addresses; or
generated using an identity key stored on the keyless vehicle system and the mobile device.

37. The method of claim 27 wherein determining the presence of the mobile device comprises:
sending, by the Bluetooth module, a key press report to the mobile device; and
verifying, by the Bluetooth module, a response, received from the mobile device, to the key press report.

38. The method of claim 37 wherein verifying the response uses a cryptographic key stored on the keyless vehicle system and the mobile device, optionally wherein the cryptographic key is a Bluetooth Long Term Key.

39. The method of claim 27 wherein determining the presence of the mobile device comprises:
successfully re-establishing an encrypted link layer communication session with the mobile device; or
determining the proximity of the mobile device.

40. The method of claim 27 further comprising discovering, by the mobile device, the Bluetooth module and initiating a connection to the Bluetooth module.

41. The method of claim 27 wherein the Bluetooth module is bonded with the mobile device using a HID-over-GATT profile of the Bluetooth module.

42. An apparatus arranged to carry out a method of operating a keyless vehicle system of a vehicle, the method comprising:
receiving, at a Bluetooth module of the keyless vehicle system a connection request from a mobile device, wherein the Bluetooth module of the keyless vehicle system is bonded as a human interface device (HID) to the mobile device;
in response to the mobile device being verified by the Bluetooth module, establishing a Bluetooth connection between the mobile device and the Bluetooth module;
in response to the vehicle detecting physical interaction, determining the presence of the mobile device; and
allowing operation of the vehicle based on the presence of the mobile device.

43. A method of associating a mobile device with a keyless vehicle system of a vehicle, the method comprising:
in response to the keyless vehicle system authenticating a user, enabling a paring mode of a Bluetooth module of the keyless vehicle system;
initiating, at the mobile device, paring of the Bluetooth module of the keyless vehicle with the mobile device, to bond the a Bluetooth module of the keyless vehicle system as a human interface device of the mobile device, such that the mobile device is paired to the keyless vehicle system and thereby authorized to operate the keyless vehicle system.

44. The method of claim 43 wherein said paring comprises:
storing an identifier of the mobile device at the keyless vehicle system; or
a cryptographic key being exchanged between the Bluetooth module and the mobile device, optionally wherein the cryptographic key is a Bluetooth Long Term Key.

45. The method of claim 43 wherein authenticating a user comprises detecting a physical key corresponding to the vehicle is present in the vehicle.

46. The method of claim 43 wherein the Bluetooth module is bonded with the mobile device using a HID-over-GATT profile of the Bluetooth module.
